(19) United States
(12) Patent Application Publication
(10) Pub. No.: US 2026/0297282 A1
(43) Pub. Date: Oct. 1, 2026

(54) RECOVERING POLYMER FROM THREE-DIMENSIONAL PRINTED OBJECTS

(71) Applicant: PERIDOT PRINT LLC, Palo Alto, CA (US)

(72) Inventors: Erica Fung, San Diego, CA (US); Alay Yemane, San Diego, CA (US); Emre Hiro Discekici, San Diego, CA (US)

(21) Appl. No.: 19/701,696

(22) Filed: Jun. 8, 2026

Related U.S. Application Data
(62) Division of application No. 17/926,986, filed on Jun. 10, 2020.

(51) Int. Cl. C08J 11/08; B29B 17/02; B29B 17/04; B29C 64/357; B29K 77/00; B33Y 40/00

(52) U.S. Cl. CPC C08J 11/08; B29B 17/02; B29B 17/0412; B29C 64/357; B33Y 40/00; B29B 2017/0293; B29B 2017/0484; B29K 2077/00; C08J 2377/00

(57) ABSTRACT

A method of recovering polymer from a three-dimensional printed object can include dissolving a polyamide polymer of a three-dimensional printed object in a polyamide-dissolving solvent to generate dissolved polyamide polymer from the three-dimensional object, where the three-dimensional printed object can include a particulate fusing compound and from about 90 wt % to about 99.9 wt % of the polyamide polymer; separating the particulate fusing compound from the polyamide-dissolving solvent and the dissolved polyamide polymer; and evaporating the polyamide-dissolving solvent from the dissolved polyamide polymer.

### CROSS-REFERENCE TO RELATED APPLICATIONS

This application is a division of co-pending U.S. application Ser. No. 17/926,986, filed Nov. 21, 2022, which itself is a national stage entry under 35 U.S.C. § 371 of International Patent Application No. PCT/US2020/036997, filed Jun. 10, 2020, each of which is incorporated herein by reference in its entirety.

### BACKGROUND

Three-dimensional (3D) printed objects may be formed by an additive printing process that may involve the application of successive layers of material, fusing agent, and heat. Polymeric three-dimensional printed objects vary from polymeric objects manufactured using other means in that they incorporate residual fusing agent components.

### BRIEF DESCRIPTION OF THE DRAWINGS

FIG. 1 is a flow diagram illustrating an example method of recovering polyamide polymer from a three-dimensional printed object in accordance with the present disclosure;

FIG. 2 is a flow diagram illustrating an example method of recovering polymer from a three-dimensional printed object in accordance with the present disclosure; and

FIG. 3 is a schematic illustration of an example recovered polymer from a three-dimensional printed object in accordance with the present disclosure.

### DETAILED DESCRIPTION

Three-dimensional printing can be an additive process involving the application of successive layers of a polymeric build material with a fusing agent printed thereon to bind the successive layers of the polymeric build material together. More specifically, a fusing agent including a radiation absorber can be selectively applied to a layer of a polymeric build material on a support bed, e.g., a build platform supporting polymeric build material, to pattern a selected region of a layer of the polymeric build material. The layer of the polymeric build material can be exposed to electromagnetic radiation, and due to the presence of the radiation absorber on the printed portions, absorbed light energy at those portions of the layer having the fusing agent printed thereon can be converted to thermal energy, causing that portion to melt or coalesce, while other portions of the polymeric build material do reach temperatures suitable to melt or coalesce. This can then be repeated on a layer-by-layer basis until the three-dimensional object is formed.

On occasion, the three-dimensional printing process may result in the formation of a failed three-dimensional object or a rejected three-dimensional object, which can generate waste. In some examples, this waste can amount to over 10MT failed three-dimensional object waster or rejected three-dimensional object waste per year. This waste cannot be recycled like other plastics due to the residual fusing agent compounds used in the manufacture of three-dimensional objects. In place of recycling, failed three-dimensional objects or rejected three-dimensional objects may be burned which can contribute to global warming or disposed of in landfills. These methods of dispensing failed three-dimensional objects or rejected three-dimensional objects from three-dimensional printing may be undesirable from an environmental viewpoint. Accordingly, new methods for recycling or recovering polymeric build material from three-dimensional printed objects may be desirable.

In accordance with this, a method of recovering polymer from a three-dimensional printed object is presented. The method can include dissolving a polyamide polymer of a three-dimensional printed object in a polyamide-dissolving solvent to generate dissolved polyamide polymer from the three-dimensional object, where the three-dimensional printed object can include a particulate fusing compound and from about 90 wt % to about 99.9 wt % of the polyamide polymer; separating the particulate fusing compound from the polyamide-dissolving solvent and the dissolved polyamide polymer; and evaporating the polyamide-dissolving solvent from the dissolved polyamide polymer. In an example, the polyamide-dissolving solvent can include a cresol, a fluorinated C2-C4 alcohol, or a combination thereof. In another example, the polyamide-dissolving solvent can include m-cresol or hexafluoroisopropanol. In yet another example, particulate fusing compound can have a D50 particle size of about 2 nm to about 500 nm and can includes carbon black, lanthanum hexaboride, tungsten bronze, indium tin oxide, aluminum zinc oxide, ruthenium oxide, silver, gold, platinum, iron pyroxene, iron phosphate, copper pyrophosphate, or a combination thereof. In a further example, the polyamide polymer can be selected from polyamide 11, polyamide 12, polyamide 6, polyamide 6,6, thermoplastic polyamide, or combinations thereof. In an example, dissolving can separate particulate fillers from the polyamide-dissolving solvent and the dissolved polyamide polymer, and separating can includes separating the particulate fusing compound and the particulate fillers from the polyamide-dissolving solvent. In one example, the evaporating can include heating the polyamide-dissolving solvent and the dissolved polyamide polymer to a temperature ranging from about 70° C. to about 100° C. for a period of time ranging from about 15 hours to about 30 hours per 10 mL of the polyamide-dissolving solvent. In another example, the separating particulate fusing compound from the dissolved polyamide polymer and the polyamide-dissolving solvent can include filtering. In yet another example, the method can further include grinding the three-dimensional printed object to a particle having a length ranging from about 3 mm to about 20 mm and a diameter ranging from about 2 mm to about 5 mm prior to dissolving. In a further example, the dissolving can further include heating the three-dimensional printed object, or particles or portions thereof, and the polyamide-dissolving solvent to a temperature ranging from about 80° C. to about 100° C. for a time period ranging from about one hour to one and half hours. In one example, the evaporating can occur in conjunction with a vacuum trap to collect the polyamide-dissolving solvent evaporated off from the dissolved polyamide polymer.

In another example of the present disclosure, a method of recovering polymer from a three-dimensional printed object can include pelletizing a three-dimensional printed object including from about 90 wt % to about 99.99 wt % polymer and from about 0.01 wt % to about 10 wt % residual fusing agent components including dried residual organic co-solvent and dried residual surfactant to form injection molding pellets having a size ranging from about 750 nm to about 10 μm. In another example, the residual fusing agent components can further include particulate fusing compound.

In a further example, recovered polymer from a three-dimensional printed object are presented. The recovered polymer can include from about 90 wt % to about 99.99 wt % polymer and from about 0.01 wt % to about 10 wt % residual fusing agent components including dried residual organic solvent and dried residual surfactant. In another example, the recovered polymer can include a polyamide and the residual fusing agent components do not include particulate fusing compound.

When discussing the method of recovering polyamide polymer from a three-dimensional printed object, a method of recovering polymer from a three-dimensional printed object, and recovered polymer from a three-dimensional printed object herein, these discussions can be considered applicable to one another whether or not they are explicitly discussed in the context of that example. Thus, for example, when discussing polymer in a method of recovering polyamide polymer from a three-dimensional printed object, such disclosure is also relevant to and directly supported in the context of method of recovering polymer from a three-dimensional printed object, the recovered polymer from a three-dimensional printed object, and vice versa.

Terms used herein will have the ordinary meaning in their technical field unless specified otherwise. In some instances, there are terms defined more specifically throughout the specification or included at the end of the present specification, and thus, these terms can have a meaning as described herein.

Methods of Recovering Polymer from a Three-Dimensional Printed Objects

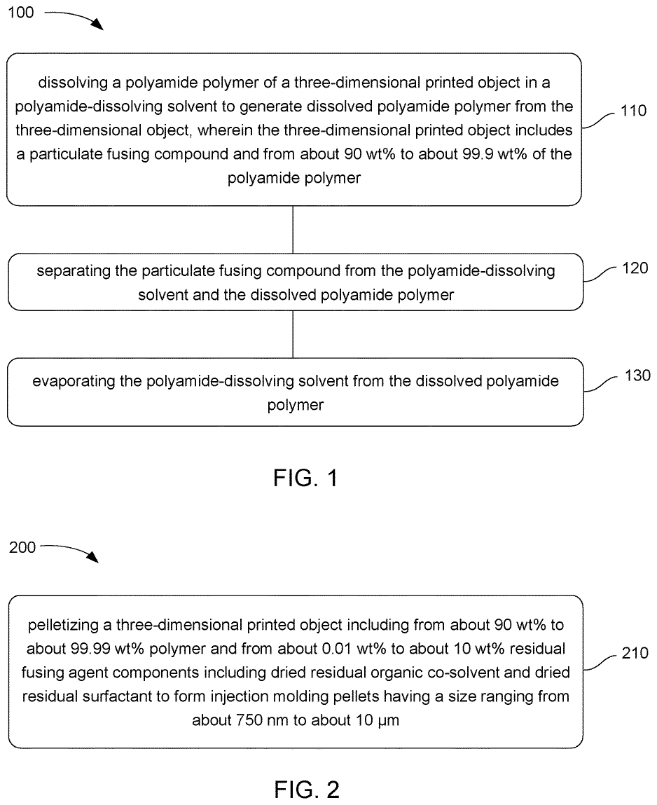

A flow diagram of an example method 100 of recovering a polymer from a three-dimensional (3D) printed object is shown in FIG. 1. This particular method is effective for recovering polyamide polymer. The method can include dissolving 110 a polyamide polymer of a three-dimensional printed object in a polyamide-dissolving solvent to generate dissolved polyamide polymer from the three-dimensional object, where the three-dimensional printed object includes a particulate fusing compound and from about 90 wt % to about 99.9 wt % of the polyamide polymer. The method can also include separating 120 the particulate fusing compound from the polyamide-dissolving solvent and the dissolved polyamide polymer and evaporating 130 the polyamide-dissolving solvent from the dissolved polyamide polymer.

The dissolving can occur in a polyamide-dissolving solvent. The polyamide-dissolving solvent can be selected from a solvent that the polymer is dissolvable within and a solvent that the particulate fusing agent compound is insoluble within. For example, a polyamide-dissolving solvent can include a cresol, a fluorinated C2-C4 alcohol, or a combination thereof. In one example, the polyamide-dissolving solvent can include a cresol. The cresol can be selected from m-cresol, p-cresol, o-cresol, or a combination thereof. In another example, the polyamide-dissolving solvent can include m-cresol. In yet another example, the polyamide-dissolving solvent can include a fluorinated C2-C4 alcohol. The fluorinated C2-C4 alcohol can be selected from 2-fluoroethanol; 1,1,1,3,3,3-hexafluoro-2-propanol; 2,2,3,3,3,-pentafluroro-1-propanol; 2,2,3,3-tetrafluoro-1-propanol; 1,1,1,-trifluoro-2-propanol; 3,3,3-trifluoro-1-propanol; 1,3-difluoro-2-propanol; 2,2-difluoro-1-propanol; 3-fluoro-1 propanol; N-(2-hydroxyethyl)formamide; nonafluoro-tert-butyl alcohol; 2,2,3,3,4,4,4-heptafluroro-1-butanol; 1,1,1,3,3,3-hexafluoro-2-methyl-2-propanol; (2R)-3,3,3-trifluoro-2-hydroxy-2-methylpropanoic acid; 2-hydroxy-2-(trifluoromethyl)propanoic acid; 1,1,1-trifluoro-2-butanol; 2-trifluoromethyl-2-propanol; hexafluoroisopropanol; or a combination thereof. In an example, the polyamide-dissolving solvent can include hexafluoroisopropanol. In yet another example, the polyamide-dissolving solvent can include m-cresol or hexafluoroisopropanol.

An amount of time to dissolve a three-dimensional printed object in the polyamide-dissolving solvent can vary. However, a three-dimensional printed object will eventually dissolve in a polyamide-dissolving solvent as long as the polyamide polymer is dissolvable in the polyamide-dissolving solvent. For example, the dissolving can take from about 72 hours to about 168 hours without heat. In some examples, an amount of time for the dissolving can be sped up by reducing a size of the three-dimensional printed object, heating the polyamide-dissolving solvent, the three-dimensional printed object, or particles or portions thereof, or a combination of these.

In one example, an amount of time to dissolve a three-dimensional printed object in the polyamide-dissolving solvent can vary based on a size of a three-dimensional printed object. Smaller three-dimensional printed objects will dissolve quicker in the polyamide-dissolving solvent than larger three-dimensional printed objects. Accordingly, in some examples, the method can further reducing a size of the three-dimensional printed object prior to dissolving the object. A three-dimensional printed object can be reduced in by grinding, cutting, crushing, sanding, or the like.

In one example, the method can further include grinding the three-dimensional printed object to a smaller size in order to reduce dissolving time. For example, the three-dimensional printed object can be ground to particles that can have a length ranging from about 3 mm to about 20 mm and a diameter ranging from about 2 mm to about 5 mm prior to dissolving. In another example, the three-dimensional printed object can be ground to particles that can have a length ranging from about 2 mm to about 4 mm or from about 3 mm to about 5 mm prior to dissolving. In yet other examples, the three-dimensional printed object can be ground to particles that can have a diameter ranging from about 3 mm to about 4 mm or from about 4 mm to about 5 mm prior to dissolving.

In another example, the dissolution time can vary based on a temperature of the polyamide-dissolving solvent. In some examples, the dissolving can be sped up by heating the polyamide-dissolving solvent, the three-dimensional printed object, or particles thereof, or a combination of these. For example, the method can include heating the three-dimensional printed object, or particles or portions thereof, and the polyamide-dissolving solvent to a temperature ranging from about 80° C. to about 100° C. for a time period ranging from about one hour to about one and a half hours. In yet other examples, the method can include heating the three-dimensional printed object and the polyamide-dissolving solvent to a temperature ranging from about 85° C. to about 95° C. for a time period of about one hour.

Upon dissolving the particulate fusing compound can be suspended in the solution of the polyamide-dissolving solvent and the polyamide powder. The particulate fusing compound can include particles of carbon black, lanthanum hexaboride, tungsten bronze, indium tin oxide, aluminum zinc oxide, ruthenium oxide, silver, gold, platinum, iron pyroxene, iron phosphate, copper pyrophosphate, or a combination thereof. In yet another example, the particulate fusing compound can include particles of carbon black. In some examples, the particulate fusing compound can occur as suspended particles that can have a D50 particle size of from about 20 μm to about 150 μm, from about 50 μm to about 150 μm, from about 20 μm to about 80 μm, or from about 75 μm to about 125 μm.

In some examples, the dissolving can also separate particulate fillers that may be present in the three-dimensional object from the three-dimensional printed object. The particulate fillers can likewise be suspended in the solution of the polyamide-dissolving solvent and the polyamide powder. Example particulate filler(s) that may be present in a three-dimensional object may be inorganic particles, such as glass beads, fiber glass, clay, silica, titanium dioxide, etc. The particulate filler that may be present can have a D50 particle size that can range from about 10 μm to about 300 μm, from about 10 μm to about 30 μm, from about 200 μm to about 300 μm, from about 50 μm to about 250 μm, or from about 10 μm to about 150 μm.

In some examples, the method can further include separating the particulate fusing compound or the particulate fusing compound and the particulate fillers from the polyamide-dissolving solvent and the dissolved polyamide polymer. The separating can include, in one example filtering the particulate fusing compound or the particulate fusing compound and the particulate fillers from the polyamide-dissolving solvent and the dissolved polyamide polymer. The filtering can occur by mechanical filtration, reverse osmosis, granular media filtration, or the like. In one example, the filtering can occur by mechanical filtration. Filtering can separate, a solution including the polyamide-dissolving solvent and the dissolved polyamide polymer from the particulate fusing compound or the particulate fusing compound and the particulate fillers.

The solution including the polyamide-dissolving solvent and the dissolved polyamide polymer can then be treated to separate the polyamide-dissolving solvent from the dissolved polyamide polymer by evaporation. The evaporation can occur by heating the polyamide-dissolving solvent and the dissolved polyamide polymer to a temperature ranging from about 70° C. to about 100° C. for a period of time ranging from about 15 hours to about 30 hours per 10 mL of the polyamide-dissolving solvent. In yet another example, the evaporation can occur by heating the polyamide-dissolving solvent and the dissolved polyamide polymer to a temperature ranging from about 80° C. to about 90° C. for a period of time ranging from about 20 hours to about 25 hours per 10 mL of the polyamide-dissolving solvent. In some examples, the evaporation can include rotary evaporation, flash evaporation, thermal and mechanical vapor recompression, plate evaporation, film evaporation, or the like. In one example, the evaporation can occur by rotary evaporation. In some examples, the evaporating can occur in conjunction with a vacuum trap. The vacuum trap can be used to collect the polyamide-dissolving solvent evaporated off from the dissolved polyamide polymer. The collected polyamide-dissolving solvent may then be reused in an additional recovery of a polyamide from a three-dimensional printed object.

Upon evaporation, a polyamide polymer is left behind. In some examples, the polyamide polymer can be selected from polyamide 6, polyamide 11, polyamide12, polyamide 6,6, thermoplastic polyamide, or combinations thereof. In an example, the polyamide polymer can be a blend of polyamide 11, polyamide, 12, and thermoplastic polymer. In yet another example, the polyamide polymer can include polyamide 12. An amount of the polyamide polymer recovered from the method can vary from about 80% to about 95% of the three-dimensional objects mass prior to the recovery, when the three-dimensional object excludes filler. In yet other examples, an amount of the polyamide polymer recovered from the method can vary from about 85% to about 95% or from about 90% to about 95% of the three-dimensional objects mass prior to the recovery, when the three-dimensional object excludes filler. When the three-dimensional object includes filler material, an amount of the polymer recovered can be from about 80% to about 95% of the polymer's mass in the three-dimensional object, for example.

In another example, a flow diagram of an alternative method 200 of recovering polymer from a three-dimensional printed object is shown in FIG. 2. The method can include pelletizing 210 a three-dimensional printed object including from about 90 wt % to about 99.99 wt % polymer and from about 0.01 wt % to about 10 wt % residual fusing agent components. The residual fusing agent components can include dried residual organic co-solvent and dried residual surfactant. In some examples, the injection molding pellets can further include particulate fusing compound. In another example, the injection molding pellets can further include particulate fillers. The method can form injection molding pellets having a size that can range from about 750 nm to about 10 μm, in one example. In yet other examples, the injection molding pellets can have a size ranging from about 1 μm to about 10 μm, from about 750 nm to about 5 μm, or from about 800 μm to about 2 μm.

The injection molding pellets can be used in injection molding of objects. In some examples, the method can further include forming an injection molded object with the injection molding pellets. During injection molding the injection molding pellets can be melted and extruded into a mold to form the injected molded object. In some examples, the melting and the extruding can include feeding the injection molding pellets into a heated barrel including a helical shaped screw, extruding a molten liquid of the injection molding pellets into the a mold cavity, and allowing the molten liquid to cool and solidify in the mold cavity to form an injection molded object having an inverse shape of the mold cavity. In yet other examples, the method can further include removing the injection molded object from the mold cavity.

An injection molded object formed using the injection molding pellets can exhibit substantially similar stiffness to a comparable injection molded object having the same dimensions that was formed from comparable injection molding pellets that include the polymer but exclude the residual fusing agent components. In an example, a stiffness of the injection molded object can be within about 1% to about 10%, within about 1% to about 5%, within about 2% to about 8%, within about 3% to about 9% or within about 5% to about 10% of a stiffness of a comparable object. Stiffness can be determined by measuring Young's modulus using a tensile test, e.g. ASTM D638.

An injection molded object formed form the injection molding pellets can also exhibit substantially similar tensile strength to a comparable injection molded object having the same dimensions that was formed from comparable injection molding pellets that include the polymer but exclude the residual fusing agent components. In an example, a tensile strength of the injection molded object can be within about 1% to about 10%, within about 1% to about 5%, within about 2% to about 8%, within about 3% to about 9% or within about 5% to about 10% of a tensile strength of a comparable object. Tensile strength can also be determined by measuring Young's modulus using a tensile test, e.g. ASTM D638.

### Recovered Polymer

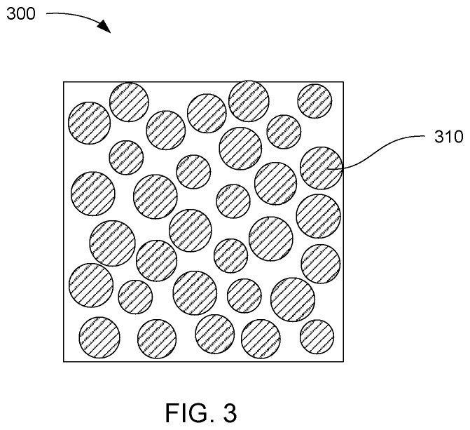

In a further example, as shown in FIG. 3, a recovered polymer 300 from a three-dimensional printed object in the form of injection molding pellets can include polymer 310, which may be in the form of polymer particles in some examples, e.g., D50 particle size from about 750 nm to about 10 μm. The recovered polymer from the method of recovering polyamide polymer may conform to a shape of the container that the method was carried out in and may not include polymer particles. The recovered polymer can include from about 90 wt % to about 99.99 wt % polymer and from about 0.01 wt % to about 10 wt % residual fusing agent components including dried residual organic solvent and dried residual surfactant. In some examples, the recovered polymer may be acquired by the method of recovering polyamide polymer or the method of recovering polymer described herein.

A polymer of the recovered polymer is not particularly limited. In one example, the polymer can include polyamide, polyethylene, polyethylene terephthalate (PET), polystyrene, polyacrylate, polyacetal, polypropylene, polycarbonate, polyester, polyurethane, acrylonitrile butadiene styrene, thermoplastic polyamide, thermoplastic polyurethane, engineering plastic, polyether ketone, polyetheretherketone (PEEK), polyethylene terephthalate, polybutylene terephthalate, polymer blends thereof, amorphous polymers thereof, core-shell polymers thereof, or a copolymer thereof. These polymers may be recovered in the form of injection molding pellets along with residual particulate fusing compound. In another example, the polymer can include polyamide 6, polyamide 11, polyamide 12, polyamide 6,6, thermoplastic polyamide, or combinations thereof. These polymers may be recovered in the form of injection molding pellets that include residual fusing agent components or as a polyamide polymer separated from the particulate fusing compound.

In some examples, the recovered polymer may include additives used in the manufacture of the three-dimensional object. These additives can include flow additives, antioxidants, inorganic filler, or any combination thereof. Typically, an amount of any of these or other similar components can be at about 5 wt % or less or at about 3 wt % of less. An example flow additive can include fumed silica. Example antioxidants can include hindered phenols, phosphites, thioethers, hindered amines, and/or the like. Example inorganic filler can include particles such as alumina, silica, fibers, carbon nanotubes, cellulose, and/or the like. In some examples, the additive may be embedded or composited with polymer during three-dimensional printing.

An amount of polymer in the recovered polymer can range from about 90 wt % to about 99.99 wt %, from about 95 wt % to about 99.9 wt %, from about 90 wt % to about 95 wt %, or from about 92 wt % to about 98 wt %. In some examples, the amount of polymer can be substantially equivalent to an amount of polymer from a recycled three-dimensional printed object or an amount of polymer in a three-dimensional printed object.

In an example, the residual fusing agent components in the recovered polymer can include dried residual organic solvent and dried residual surfactant. The dried residual organic surfactant can include residue from 1-(2-hydroxyethyl)-2-pyrollidinone, 2-pyrrolidinone, 2-methyl-1,3-propanediol, 1,5-pentanediol, triethylene glycol, tetraethylene glycol, 1,6-hexanediol, tripropylene glycol methyl ether, ethoxylated glycerol-1 (LEG-1), ethanol, methanol, propanol, acetone, tetrahydrofuran, hexane, 1-butanol, 2-butanol, tert-butanol, isopropanol, propylene glycol, methyl ethyl ketone, dimethylformamide, 1,4-dioxone, acetonitrile, 1,2-butanediol, 1-methyl-2,3-propanediol, 2-pyrrolidone, glycerol, 2-phyenoxyethanol, 2-phenylethanol, 3-phenylpropanol, or a combination thereof.

The dried residual surfactant can include residue from non-ionic surfactants, anionic surfactants, cationic surfactants, or a combination thereof. Example non-ionic surfactants can include a self-emulsifiable, nonionic wetting agent based on acetylenic diol chemistry (e.g., SURFYNOL® SEF from Air Products and Chemicals, Inc. (USA)), a nonionic fluorosurfactant (e.g., CAPSTONE® fluorosurfactants from DuPont (USA)), and combinations thereof. In other examples, the surfactant residue can include ethoxylated low-foam wetting agent (e.g., SURFYNOL® 440, SURFYNOL® 465, or SURFYNOL® CT-111 from Air Products and Chemical Inc. (USA)) or an ethoxylated wetting agent and molecular defoamer (e.g., SURFYNOL® 420 from Air Products and Chemical Inc. (USA)). Still other surfactant residue can include non-ionic wetting agents and molecular defoamers (e.g., SURFYNOL® 104E from Air Products and Chemical Inc. (USA)), non-ionic, alkylphenylethoxylate, and solvent free surfactant blends (e.g., SURFYNOL® CT-211 from Air Products and Chemicals, Inc. (USA)), water-soluble, non-ionic surfactants (e.g., TERGITOL® TMN-6, TERGITOL® 15S7, and TERGITOL® 15S9 from The Dow Chemical Company (USA)), and combinations thereof. In another example, the surfactant residue can include residue from a non-ionic organic surfactant (e.g., TEGO® Wet 510 from Evonik Industries AG (Germany)), a non-ionic secondary alcohol ethoxylate (e.g., TERGITOL® 15-S-5, TERGITOL® 15-S-7, TERGITOL® 15-S-9, and TERGITOL® 15-S-30 all from Dow Chemical Company (USA)), and combinations thereof. Examples of anionic surfactants can include alkyldiphenyloxide disulfonate (e.g., DOWFAX® 8390 and DOWFAX® 2A1 from The Dow Chemical Company (USA)). An example of cationic surfactants can include dodecyltrimethylammonium chloride and hexadecyldimethylammonium chloride.

In some examples, the residual fusing agent components can further include a particulate fusing compound. The particulate fusing compound can include, in an example, carbon black, lanthanum hexaboride, tungsten bronze, indium tin oxide, aluminum zinc oxide, ruthenium oxide, silver, gold, platinum, iron pyroxene, iron phosphate, copper pyrophosphate, metal dithiolene complex, metal nanoparticles, oxonol, squarylium, chalcogenopyrylarylidene, bis(chalcogenopyrylo)polymethine, bis(aminoaryl)polymethine, merocyanine, trinuclear cyanine, indene-crosslinked polymethine, oxyindolidine, iron complexes, quinoids, nickel-dithiolene complex, cyanine dyes, or a combination thereof. In another example, the particulate fusing compound can include carbon black, lanthanum hexaboride, tungsten bronze, indium tin oxide, aluminum zinc oxide, ruthenium oxide, silver, gold, platinum, iron pyroxene, iron phosphate, copper pyrophosphate, or a combination thereof. In one example, the residual fusing agent components may exclude particulate fusing compound. Recovered polymer that does not include particulate fusing compound may be recovered from a three-dimensional printed object using the method of recovering polyamide polymer, as previously described herein.

In yet other examples, the residual fusing agent components can include dried residual dispersant. Dried residual dispersants can include polyoxyethylene glycol octylphenol ethers, ethoxylated aliphatic alcohols, carboxylic esters, polyethylene glycol ester, anhydrosorbitol ester, carboxylic amide, polyoxyethylene fatty acid amide, poly (ethylene glycol) p-isooctyl-phenyl ether, sodium polyacrylate, and combinations thereof.

In yet other examples, the residual fusing agent components may further include dried residue from a chelating agent, an antimicrobial agent, a buffer, or a combination thereof. Examples of chelating agents can include disodium ethylene-diaminetetraacetic acid (EDTA-Na), ethylene diamine tetra acetic acid (EDTA), and methyl-glycinediacetic acid (e.g., TRILON® M from BASF Corp., Germany). Example antimicrobial agents can include the NUOSEPT® (Ashland Inc., USA), VANCIDE® (R.T. Vanderbilt Co., USA), ACTICIDE® B20 and ACTICIDE® M20 (Thor Chemicals, U.K.), PROXEL® GXL (Arch Chemicals, Inc., USA), BARDAC® 2250, 2280, BARQUAT® 50-65B, and CARBOQUAT®250-T, (Lonza Ltd. Corp., Switzerland), KORDEK® MLX (The Dow Chemical Co., USA), and combinations thereof. Example buffer can include a poly-hydroxy functional amine, potassium hydroxide, 2-[4-(2-hydroxyethyl) piperazin-1-yl]ethane sulfonic acid, 2-amino-2-(hydroxymethyl)-1,3-propanediol (TRIZMA® sold by Millipore-Sigma, Germany), 3-morpholinopropanesulfonic acid, triethanolamine, 2-[bis-(2-hydroxyethyl)-amino]-2-hydroxymethyl propane-1,3-diol (bis tris methane), N-methyl-D-glucamine, N,N,N′N′-tetrakis-(2-hydroxyethyl)-ethylenediamine and N,N,N′N′-tetrakis-(2-hydroxypropyl)-ethylenediamine, beta-alanine, betaine, or mixtures thereof.

An amount of residual fusing agent in the recovered polymer can range from about 0.01 wt % to about 10 wt %. In yet other examples, an amount of the residual fusing agent can range from about 0.05 wt % to about 5 wt %, from about 0.1 wt % to about 2.5 wt %, from about 1 wt % to about 10 wt %, from about 2 wt % to about 8 wt %, or from about 2.5 wt % to about 7.5 wt %.

### Definitions

It is noted that, as used in this specification and the appended claims, the singular forms “a,” “an,” and “the” include plural referents unless the content clearly dictates otherwise.

The term “about” as used herein, when referring to a numerical value or range, allows for a degree of variability in the value or range, for example, within 10%, or, in one aspect within 5%, of a stated value or of a stated limit of a range. The term “about” when modifying a numerical range is also understood to include as one numerical subrange a range defined by the exact numerical value indicated, e.g., the range of about 1 wt % to about 5 wt % includes 1 wt % to 5 wt % as an explicitly supported sub-range.

The terms “size” or “particle size,” as used herein, refer to the diameter of a substantially spherical particle, or the effective diameter of a non-spherical particle, e.g., the diameter of a sphere with the same mass and density as the non-spherical particle as determined by weight. Particle size information can be determined and/or verified using a scanning electron microscope (SEM), or can be measured using a particle analyzer such as a MASTERSIZER™ 3000 available from Malvern Panalytical, for example. The particle analyzer can measure particle size using laser diffraction. A laser beam can pass through a sample of particles and the angular variation in intensity of light scattered by the particles can be measured. Larger particles scatter light at smaller angles, while small particles scatter light at larger angles. The particle analyzer can then analyze the angular scattering data to calculate the size of the particles using the Mie theory of light scattering. Particle size can be reported as a volume equivalent sphere diameter. An average particle size can refer to a mathematical average of the particle sizes. Alternatively, the particle size can be based on a particle size distribution including a D50 particle size, where 50% of the particles are larger than the D50 value and 50% of the particles are smaller than the D50 value.

As used herein, a plurality of items, structural elements, compositional elements, and/or materials may be presented in a common list for convenience. However, these lists should be construed as though an individual member of the list is identified as a separate and unique member. Thus, no individual member of such list should be construed as a de facto equivalent of any other member of the same list based on presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, as well as to include all the individual numerical values or sub-ranges encompassed within that range as the individual numerical value and/or sub-range is explicitly recited. For example, a weight ratio range of about 1 wt % to about 20 wt % should be interpreted to include the explicitly recited limits of 1 wt % and 20 wt % and to include individual weights such as about 2 wt %, about 11 wt %, about 14 wt %, and sub-ranges such as about 10 wt % to about 20 wt %, about 5 wt % to about 15 wt %, etc.

### EXAMPLES

The following illustrates examples of the present disclosure. Numerous modifications and alternative compositions, methods, and systems may be devised without departing from the present disclosure. The appended claims are intended to cover such modifications and arrangements.

### Example 1—Recovering Polyamide Polymer from a Three-Dimensional Printed Object

A three-dimensional printed object having a rectangular dimension of 2 inches by 4 inches and a thickness of from about ⅛ inch to about ¼ inch was printed using polyamide 12 polymer particles and a carbon black particulate fusing compound. The three-dimensional printed object was then recycled by grinding the three-dimensional printed object to particles having a D50 particle size ranging from about 1 mm to about 5 mm, followed by suspending 0.055 g of the particles per 13 mL m-cresol polyamide-dissolving solvent. The polyamide-dissolving solvent and the ground particles of the three-dimensional printed object were then heated to about 100° C. for about 1.5 hours. Upon dissolving, a solution remained that included the polyamide-dissolving solvent and dissolved polyamide powder with the particulate fusing compound suspended therein. The particulate fusing compound was separated from the solution including polyamide-dissolving solvent and the dissolved polyamide polymer by mechanically filtering the solution using a 0.7 μm Whatman® 6825-2517 puradisc (available from Millipore-Sigma, Germany). Following separating, the puradisc was black indicating that the puradisc retained the carbon black particulate fusing compound that was originally present in the three-dimensional printed object. An optically clear filtered solution remained. To separate the m-cresol polyamide-dissolving solvent from the dissolved polyamide polymer, the filtered solution was then placed in a vacuum oven for about 15 hours to about 30 hours per 10-mL of the m-cresol at about 80° C. until the m-cresol polyamide-dissolving solvent was evaporated off. A vacuum trap was used in conjunction with the vacuum oven to recover the m-cresol, thereby retaining the m-cresol for future use. Neat polyamide 12 powder was recovered. The recovered polyamide 12 powder weighed about 90% of the initial mass of the three-dimensional printed object. Carbon black was not visibly present in the recovered polyamide 12 powder which exhibited a pale yellow appearance.

### Example 2—Recovering Polyamide Polymer from a Three-Dimensional Printed Object Including Particulate Fillers

Two three-dimensional printed objects having a rectangular dimension of 2 inches by 4 inches and a thickness of from about ⅛ inch to about ¼ inch were printed using a build material and a carbon black particulate fusing compound. Object A was printed using a build material that included 61.6 wt % polyamide 12 polymer particles admixed with about 38.4 wt % glass bead particulate filler. Object B was printed using a build material that included 97 wt % polyamide 12 polymer particles with about 3 wt % glass bead particulate filler.

The polymer of Object A and Object B were then recovered. The recovering occurred as indicated in Example 1, except that upon dissolving, a solution including the polyamide-dissolving solvent and dissolved polyamide powder had suspended particulate fusing compound and suspended glass bead particulate filler. The suspended particulate fusing compound and suspended glass bead particulate filler were both separated from the polyamide-dissolving solvent and the dissolved polyamide polymer by mechanically filtering. The recovered material from Object A was had a polyamide 12 content of 99.1 wt % and the recovered material from Object B had a polyamide 12 content of about 99.7 wt %.

### Example 3—Recovered Polymer from a Three-Dimensional Printed Object

Multiple three-dimensional printed objects having a rectangular dimension of 2 inches by 4 inches and a thickness of from about ⅛ inch to about ¼ inch were printed using polyamide 12 polymer particles and a carbon black particulate fusing compound. The three-dimensional objects were ground and shredded into particles having a size smaller than one-half inch in length and width. The particles were then melted and molded into multiple shapes of dog bones (or barbells). Two control molded object including only polyamide 12 particles were also formed in the shape of a dog bone. All of the dog bones had an elongated middle section flanked by two end sections that were formed having a larger size, so that the middle section was the structurally weakest section to test for stiffness and other mechanical properties. The middle section was formed with cross-sectional direction dimensions of about 3 mm×4 mm in cross-sectional diameter (perpendicular to the length of the middle section). The end sections were formed having dimensions of about 9.53 mm×3.2 mm in cross-sectional diameter.

All of the dog bone samples were then evaluated for ultimate tensile strength (UTS) and stiffness, both measured in megapascal (MPa). In order to measure the tensile strength, the dog bone objects were gripped at the end sections and a stress or force in relation to the pulling apart of the two ends and stressing the middle portion using an Instron tensiometer with a pull rate of about 10 mm per minute. The resulting data was averaged (mean) for the experimental objects and is shown in Table 1 below. The dog bone samples were also evaluated for young's modulus, e.g. stiffness. The resulting data was averaged (mean) and is also shown in Table 1 below.

TABLE 1
Injection Molded Objects

| | Control | Recycled | Percent |
|---|---|---|---|
| | Polyamide Object | Polyamide Object | Reduction |
| Tensile Stress | 52 | 48 | 8% |
| (mean MPa) | | | |
| Young's Modulus | 1600 | 1504 | 6% |
| (mean MPa) | | | |

While the three-dimensional dog bones formed from the recycled polyamide powder had slightly lower tensile stress and Young's Modulus values, the overall values were not significantly lower. This test indicated that three-dimensional printed objects can be used to form injection molding pellets and ultimately injected molded objects. The inclusion of residual fusing agent components in the injection molding pellets, which are not generally present in other injection molding pellets, does not significantly affect the overall strength of an injection molded object formed therefrom.

1.-11. (canceled)

12. A method of recycling a polymer from a three-dimensional printed object, comprising pelletizing a recovered product from the three-dimensional printed object, the recovered product including from about 90 wt % to about 99.99 wt % of a polymer and from about 0.01 wt % to about 10 wt % of residual fusing agent components including dried residual organic co-solvent and dried residual surfactant to form injection molding pellets having a size ranging from about 750 nm to about 10 μm.

13. The method of claim 12, wherein the residual fusing agent components further include a particulate fusing compound.

14. Recovered polyamide polymer from a three-dimensional printed object including i) a polyamide polymer and ii) a particulate fusing compound having a D50 particle size of from about 20 μm to about 150 μm and is selected from the group consisting of carbon black, lanthanum hexaboride, tungsten bronze, indium tin oxide, aluminum zinc oxide, ruthenium oxide, silver, gold, platinum, iron pyroxene, iron phosphate, copper pyrophosphate, and a combination thereof, wherein the recovered polyamide polymer is obtained by a method comprising:
dissolving the polyamide polymer of the three-dimensional printed object in a polyamide-dissolving solvent to generate dissolved polyamide polymer from the three-dimensional printed object, wherein the polyamide-dissolving solvent is selected from the group consisting of a cresol, a fluorinated C2-C4 alcohol, and a combination thereof;
separating the particulate fusing compound from the polyamide-dissolving solvent and the dissolved polyamide polymer; and
evaporating the polyamide-dissolving solvent from the dissolved polyamide polymer,
wherein the recovered polymer comprises from about 90 wt % to about 99.99 wt % of the polyamide polymer and from about 0.01 wt % to about 10 wt % of the residual fusing agent components.

15. (canceled)

16. The method of claim 12, wherein the polymer is a polyamide polymer and prior to pelletizing, the method further comprises obtaining the recovered product from the three-dimensional product by a process consisting of:
dissolving the polyamide polymer in a polyamide-dissolving solvent to generate dissolved polyamide polymer from the three-dimensional printed object, wherein the polyamide-dissolving solvent is selected from the group consisting of a cresol, a fluorinated C2-C4 alcohol, and a combination thereof;
separating the particulate fusing compound from the polyamide-dissolving solvent and the dissolved polyamide polymer; and
evaporating the polyamide-dissolving solvent from the dissolved polyamide polymer.

17. The method of claim 16, wherein the evaporating includes heating the polyamide-dissolving solvent and the dissolved polyamide polymer to a temperature ranging from about 70° C. to about 100° C. for a period of time ranging from about 15 hours to about 30 hours per 10 mL of the polyamide-dissolving solvent.

18. The method of claim 16, wherein the separating of the particulate fusing compound from the dissolved polyamide polymer and the polyamide-dissolving solvent includes filtering.

19. The method of claim 16, wherein the evaporating occurs in conjunction with a vacuum trap to collect the polyamide-dissolving solvent evaporated off from the dissolved polyamide polymer.

20. The method of claim 16, wherein the dried residual organic co-solvent includes dried residual polyamide-dissolving solvent.

21. The method of claim 16, wherein the evaporating occurs in conjunction with a vacuum trap to collect the polyamide-dissolving solvent evaporated off from the dissolved polyamide polymer.

22. The method of claim 12, wherein:
the polymer is a polyamide polymer;
the three-dimensional printed object further includes a particulate fusing compound having a D50 particle size of from about 20 pnm to about 150 μm and is selected from the group consisting of carbon black, lanthanum hexaboride, tungsten bronze, indium tin oxide, aluminum zinc oxide, ruthenium oxide, silver, gold, platinum, iron pyroxene, iron phosphate, copper pyrophosphate, and a combination thereof; and
prior to pelletizing, the method further comprises obtaining the recovered product from the three-dimensional product by a process comprising:
dissolving the polyamide polymer in a polyamide-dissolving solvent to generate dissolved polyamide polymer from the three-dimensional printed object;
separating the particulate fusing compound from the polyamide-dissolving solvent and the dissolved polyamide polymer; and
evaporating the polyamide-dissolving solvent from the dissolved polyamide polymer.

23. The method of claim 22, wherein the evaporating includes heating the polyamide-dissolving solvent and the dissolved polyamide polymer to a temperature ranging from about 70° C. to about 100° C. for a period of time ranging from about 15 hours to about 30 hours per 10 mL of the polyamide-dissolving solvent.

24. The method of claim 22, wherein the separating of the particulate fusing compound from the dissolved polyamide polymer and the polyamide-dissolving solvent includes filtering.

25. The method of claim 22 wherein prior to dissolving, the method further comprises grinding the three-dimensional printed object to particles with each particle having a length ranging from about 3 mm to about 20 mm and a diameter ranging from about 2 mm to about 5 mm.

26. The method of claim 22, wherein the evaporating occurs in conjunction with a vacuum trap to collect the polyamide-dissolving solvent evaporated off from the dissolved polyamide polymer.

27. The method of claim 22, wherein the dried residual organic co-solvent includes dried residual polyamide-dissolving solvent.

28. The method of claim 22, wherein the polyamide-dissolving solvent is selected from the group consisting of a cresol, a fluorinated C2-C4 alcohol, and a combination thereof.

29. Injection molding pellets obtained by the method of claim 12.
